(19) United States
(12) Patent Application Publication
(10) Pub. No.: US 2013/0016135 A1
(43) Pub. Date: Jan. 17, 2013

(54) DISPLAY SYSTEM AND CONTROL METHOD THEREOF

(71) Applicants: Shou-Cheng WANG, Miao-Li County (TW); Tse-Yuan CHEN, Miao-Li County (TW); Chih-Chiang TSENG, Miao-Li County (TW); Du-Zen PENG, Miao-Li County (TW)

(72) Inventors: Shou-Cheng WANG, Miao-Li County (TW); Tse-Yuan CHEN, Miao-Li County (TW); Chih-Chiang TSENG, Miao-Li County (TW); Du-Zen PENG, Miao-Li County (TW)

(73) Assignees: CHIMEI INNOLUX CORPORATION, Miao-Li County (TW); INNOCOM TECHNOLOGY(SHENZHEN) CO., LTD., Longhua Town (CN)

(21) Appl. No.: 13/542,613

(22) Filed: Jul. 5, 2012

(30) Foreign Application Priority Data
Jul. 13, 2011 (TW) 100124727

(51) Int. Cl. G09G 5/10

(52) U.S. Cl. 345/690

(57) ABSTRACT

A display system including a driving circuit and a display panel is disclosed. The display panel displays an image according to the data signals and the scan signals and includes a first driving unit, a second driving unit, a first luminous element, a second luminous element and a third luminous element. The first driving unit includes a first driving transistor to generate a first driving current. The second driving unit includes a second driving transistor to generate a second driving current. The first luminous element is lighted according to the first driving current when a first emitting signal is activated. The second luminous element is lighted according to the first driving current when a second emitting signal is activated. The third luminous element is lighted according to the second driving current when the first emitting signal is activated.

### CROSS REFERENCE TO RELATED APPLICATIONS

This Application claims priority of Taiwan Patent Application No. 100124727, filed on Jul. 13, 2011, the entirety of which is incorporated by reference herein.

### BACKGROUND OF THE INVENTION

1. Field of the Invention

The invention relates to a display system, and more particularly to a display system, which comprises a driving unit shared by two luminous elements.

2. Description of the Related Art

Generally, each display panel of a flat display device comprises a plurality of pixels. Each pixel at least comprises a driving transistor and a luminous element. The driving transistor generates a driving current according to an image signal. The luminous element provides a corresponding brightness according to the driving current. However, the driving transistors of the different pixels may comprise different threshold voltages due to manufacturing procedures. When the driving transistors with different threshold voltages receive the same image signal, the driving transistors may generate different driving currents such that the luminous elements display different brightness.

To solve the problem where the different threshold voltages of the driving transistors interfere with the brightness of the luminous elements, a compensation unit in a pixel to compensate for the occurrence of the different threshold voltages of the driving transistors is often used as a conventional method. However, with the development of technology, the size of a flat display device has increased. Accordingly, if each sub-pixel comprises a compensation unit, the aperture rate of the display panel would be reduced.

### BRIEF SUMMARY OF THE INVENTION

In accordance with an embodiment, a display system comprises a driving circuit and a display panel. The driving circuit generates a plurality of data signals and a plurality of scan signals according to an image input signal and a plurality of synchronization signals. The display panel displays an image according to the data signals and the scan signals and comprises a first driving unit, a second driving unit, a first luminous element, a second luminous element and a third luminous element. The first driving unit comprises a first driving transistor to generate a first driving current. The second driving unit comprises a second driving transistor to generate a second driving current. The first luminous element is lighted according to the first driving current when a first emitting signal is activated. The second luminous element is lighted according to the first driving current when a second emitting signal is activated. The third luminous element is lighted according to the second driving current when the first emitting signal is activated.

A control method for controlling a plurality of pixels is provided. Each pixel is coupled to one of a first scan electrode, a second scan electrode and a third scan electrode and comprises a first sub-pixel, a second sub-pixel and a third sub-pixel. The first, the second and the third scan electrodes are sequentially arranged. The first, the second and the third sub-pixels are sequentially arranged along a horizontal direction. A first pixel, a second pixel and a third pixel among the pixels are sequentially arranged and are coupled to the first scan electrode. A fourth pixel, a fifth pixel and a sixth pixel among the pixels are sequentially arranged and are coupled to the second scan electrode. A seventh pixel among the pixels is coupled to the third scan electrode. An exemplary embodiment of the control method is described in the following. A portion of the sub-pixels of the pixel is lighted. When the first and the third sub-pixels of the first pixel are lighted and the second sub-pixel of the first pixel is not lighted, a second sub-pixel of the second pixel is lighted, a first sub-pixel and a third sub-pixel of the second pixel are not lighted, a first sub-pixel and a third sub-pixel of the third pixel are lighted, and a second sub-pixel of the third pixel is not lighted. When the first, the second and the third sub-pixels are lighted, the first, the second and the third sub-pixels of the second and the third pixels are lighted.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a display system;

FIGS. 2 and 3 are schematic diagrams of exemplary embodiments of a pixel;

FIG. 4 is a schematic diagram of an exemplary embodiment of a driving circuit; and

FIG. 5A is a schematic diagrams of exemplary embodiments of a control method to light pixels.

FIG. 5B is a schematic diagrams of exemplary embodiments of a control method to light pixels.

FIG. 6A is a schematic diagrams of exemplary embodiments of a control method to light pixels.

FIG. 6B is a schematic diagrams of exemplary embodiments of a control method to light pixels.

FIG. 7A is a schematic diagrams of exemplary embodiments of a control method to light pixels.

FIG. 7B is a schematic diagrams of exemplary embodiments of a control method to light pixels.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

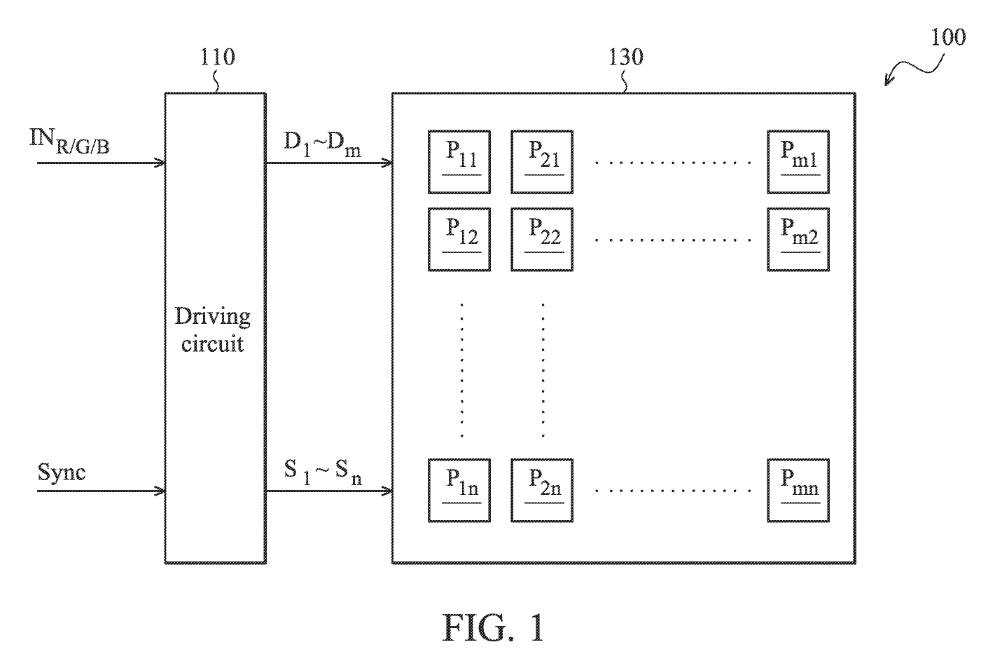

FIG. 1 is a schematic diagram of an exemplary embodiment of a display system. The display system 100 comprises a driving circuit 110 and a display panel 130. The driving circuit 110 generates data signals D˜Dₘ and scan signals S₁˜Sₙ according to an image input signal IN_{R/G/B} and a synchronization signal group Sync. In one embodiment, the synchronization signal group Sync may comprise a vertical synchronization signal and a horizontal synchronization signal.

The display panel 130 comprises pixels P₁₁˜Pₘₙ and displays a corresponding image according to the data signals D₁˜Dₘ and the scan signals S₁˜Sₙ. In this embodiment, each of the pixels P₁₁˜Pₘₙ comprises four sub-pixels to provide a red light, a green light, a blue light and a white light, but the disclosure is not limited thereto. In another embodiment, each of the pixels P₁₁˜Pₘₙ comprises three sub-pixels to provide a red light, a green light and a blue light. In some embodiments, each of the pixels P₁₁˜Pₘₙ comprises four sub-pixels to provide a red light, a green light and two blue lights.

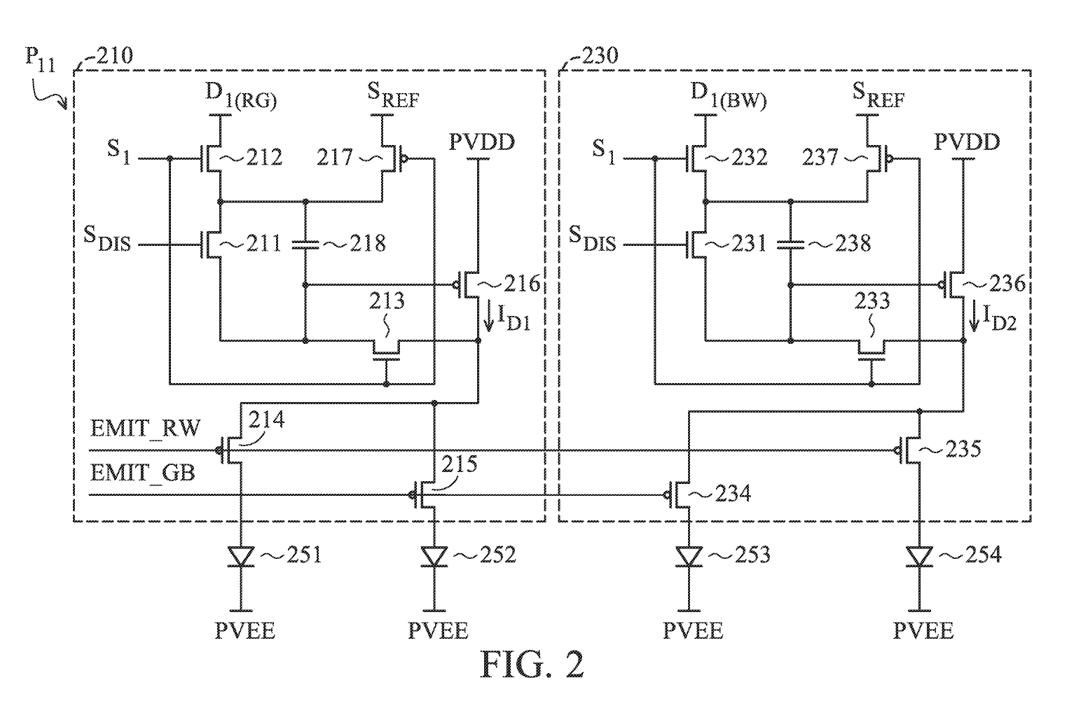

Since the structures of the pixels P₁₁˜Pₘₙ are the same, the pixel P₁₁ is given as an example. FIG. 2 is a schematic diagram of an exemplary embodiment of a pixel. The pixel P₁₁ comprises driving units 210, 230 and luminous elements 251˜254.

The driving unit 210 receives the scan signal S₁ and the data signal D_{1(RG)}. During the different frame periods, the driving unit 210 generates the different driving currents according to the different data signals, which are transmitted by a data line. In another embodiment, the driving unit 210 receives the different data signals via the different data lines.

The driving unit 210 comprises a driving transistor 216. The driving transistor 216 generates a driving current I_{D1}. In this embodiment, the driving unit 210 comprises a compensation function and a driving function, but the disclosure is not limited thereto. In other embodiments, the driving unit 210 only comprises a driving function. As shown in FIG. 2, the driving unit 210 further comprises transistors 211˜217 and a capacitor 218. The transistors 211˜217 are controlled according to a control signal S_{DIS} and a reference level S_{REF} such that a threshold voltage of the transistor 216 is extracted and the extracted threshold voltage is stored in the capacitor 218. Thus, when the transistor 216 generates the driving current I_{D1} according to the stored voltage in the capacitor 218, the driving current I_{D1} is not interfered with by the threshold voltage of the transistor 216.

The luminous elements 251 and 252 are lighted according to the driving current I_{D1}. In this embodiment, the driving unit 210 comprises the emitting transistors 214 and 215. The emitting transistor 214 is coupled to the driving transistor 216 and the luminous element 251 in series between operation voltages PVDD and PVEE. The emitting transistor 215 is coupled to the driving transistor 216 and the luminous element 252 in series between the operation voltages PVDD and PVEE.

When an emitting signal EMIT-RW is activated, the emitting transistor 214 provides the driving current I_{D1} to light the luminous element 251. When an emitting signal EMIT-GB is activated, the emitting transistor 215 provides the driving current I_{D1} to light the luminous element 252. In this embodiment, when the luminous element 251 is lighted, the luminous element 252 is not lighted. When the luminous element 252 is lighted, the luminous element 251 is not lighted.

The driving unit 230 receives the scan signal S₁ and the data signal D_{1(BW)}. During the different frame periods, the driving unit 230 generates the different driving currents (e.g. I_{D2}) according to the different data signals (e.g. D_{1(BW)}), which are transmitted by a data line. In another embodiment, the driving unit 230 receives the different data signals via different data lines.

The driving unit 230 comprises a driving transistor 236. The driving transistor 236 generates the driving current I_{D2}. In this embodiment, the driving unit 230 has a compensation function and comprises transistors 231˜237 and a capacitor 238. The transistors 231˜237 are controlled according to the control signal S_{DIS} and the reference level S_{REF} such that a threshold voltage of the transistor 236 is extracted and the extracted threshold voltage is stored in the capacitor 238. Thus, when the transistor 236 generates the driving current I_{D2} according to the stored voltage in the capacitor 238, the driving current I_{D2} is not interfered with by the threshold voltage of the transistor 236.

In this embodiment, the driving unit 230 comprises the emitting transistors 234 and 235. The emitting transistor 234 is coupled to the driving transistor 236 and the luminous element 253 in series between the operation voltages PVDD and PVEE. The emitting transistor 235 is coupled to the driving transistor 236 and the luminous element 254 in series between the operation voltages PVDD and PVEE.

When the emitting signal EMIT-GB is activated, the emitting transistor 234 provides the driving current I_{D2} to the luminous element 253. Thus, the luminous element 253 is lighted according to the driving current I_{D2}. When the emitting signal EMIT-RW is activated, the emitting transistor 235 provides the driving current I_{D2} to the luminous element 254. Thus, the luminous element 254 is lighted according to the driving current I_{D2}. In this embodiment, when the luminous element 253 is lighted, the luminous element 254 is not lighted. When the luminous element 254 is lighted, the luminous element 253 is not lighted.

The invention does not limit the kinds of the luminous elements 251˜254. In one embodiment, the luminous elements 251˜254 are organic light-emitting diodes (OLEDs). In this embodiment, the luminous elements 251˜254 provide the different colored lights, which may comprise a red light, a green light, a blue light and a white light.

In another embodiment, the color of the light provided by the luminous element 251 is the same as the color provided by the luminous element 252. The color of the light provided by the luminous element 253 is the same as the color provided by the luminous element 254. For example, the color of the light provided by the luminous element 251 is red and the color of the light provided by the luminous element 253 is blue. In this embodiment, the luminous elements 251 and 252 are disposed in the different rows. For example, the luminous element 251 is one of the luminous elements of the pixel P₁₁, the luminous element 252 is one of the luminous elements of the pixel P₁₂, the luminous element 253 is another of the luminous elements of the pixel P₁₁, and the luminous element 254 is another of the luminous elements of the pixel P₁₂.

In other embodiments, two of the luminous elements 251˜254 provide the same color. For example, the light provided by the luminous element 251 is a red light, the lights provided by the luminous elements 252 and 253 are blue lights, and the light provided by the luminous element 254 is a green light.

In this embodiment, the driving unit 210 drives the luminous elements 251 and 252, and the driving unit 230 drives the luminous elements 253 and 254, but the disclosure is not limited thereto. In other embodiments, the driving unit 210 may drive two or more luminous elements and the driving unit 230 only drives one luminous element.

The invention does not limit the timing for which the luminous elements are lighted. In one embodiment, when the luminous element 251 is lighted, the luminous elements 252 and 253 are not lighted and the luminous element 254 is lighted. In some embodiments, when the luminous element 251 is lighted, the luminous elements 252 and 254 are not lighted and the luminous element 253 is lighted.

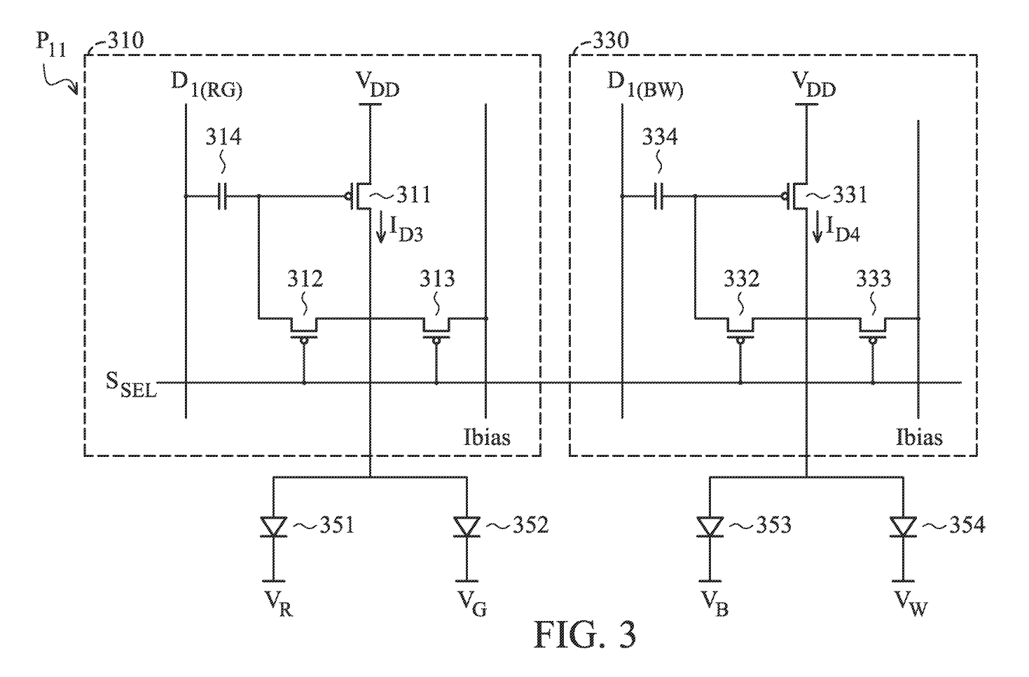

Additionally, the invention does not limit the circuit structures of the driving units 210 and 230. Any circuit can serve as the driving unit 210 or 230, as long as the circuit is capable of generating a driving current to drive a luminous element. In other embodiments, a driving unit not only has the driving function, but also a compensation function to avoid the situation where the driving current is interfered with by a threshold voltage of a transistor. FIGS. 2 and 3 show the different driving units, but the disclosure is not limited thereto.

In FIG. 2, when the emitting signal EMIT_RW or EMIT_GB is activated, the corresponding luminous elements are lighted. In other embodiments (as shown in FIG. 3), the voltage across a luminous element is controlled to light the luminous element.

In FIG. 3, the driving unit 310 not only has a driving function, but also a compensation function. In this embodiment, the driving unit 310 comprises transistors 311˜313 and a capacitor 314. A control signal S_{SEL} controls the transistors 311˜313 to extract the threshold voltage of the transistor 311. The extracted threshold voltage is stored in the capacitor 314. Thus, when the transistor 311 generates a driving current I_{D3} according to the threshold voltage stored in the capacitor 314, a situation where the brightness of the luminous element 351 is interfered with by the threshold voltage of the transistor 311 can be compensated. In other words, the driving current I_{D3} is not interfered with by the threshold voltage of the transistor 311.

In this embodiment, the driving transistor 311 is coupled to the luminous element 351 in series between the operation voltage PVDD and the emitting signal V_{R}. The driving transistor 311 is coupled to the luminous element 352 in series between the operation voltage PVDD and the emitting signal V_{G}. The emitting signals V_{R} and V_{G} are controlled to appropriately light the luminous elements 351 and 352.

For example, if the voltage difference between the operation voltage PVDD and the emitting signal V_{R} exceeds the threshold voltage of the luminous element 351, the luminous element 351 is lighted according to the driving current I_{D3}. In one embodiment, when the operation voltage PVDD is a positive value and the emitting signal V_{R} is a negative value, the luminous element 351 is lighted. Contrarily, when the emitting signal V_{R} is floating, the luminous element 351 is not lighted. Thus, when the emitting signal V_{R} or V_{G} is appropriately controlled, the luminous element 351 or 352 can be lighted according to the driving current I_{D3}.

The driving unit 330 comprises transistors 331˜333 and a capacitor 334. The control signal S_{SEL} controls the transistors 321˜323 to extract the threshold voltage of the transistor 331. The extracted threshold voltage is stored in the capacitor 334. Thus, when the transistor 331 generates a driving current I_{D4} according to the extracted threshold voltage stored in the capacitor 334, the driving current I_{D4} is not interfered with by the threshold voltage of the transistor 331.

In this embodiment, the driving transistor 331 is coupled to the luminous element 353 in series between the operation voltage PVDD and the emitting signal V_{B}. The driving transistor 331 is coupled to the luminous element 354 in series between the operation voltage PVDD and the emitting signal V_{W}. The emitting signals V_{B} and V_{W} are controlled such that the luminous element 353 or 354 is lighted according to the driving current I_{D4}.

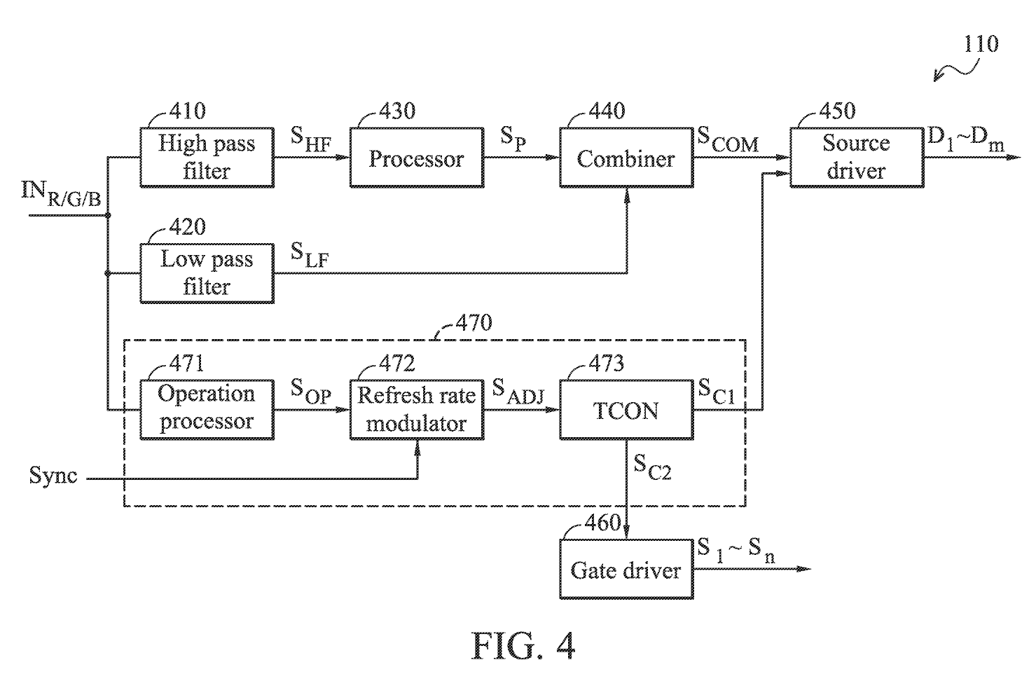

FIG. 4 is a schematic diagram of an exemplary embodiment of a driving circuit. The driving circuit 110 comprises a high pass filter 410, a low pass filter 420, a processor 430, a combiner 440, a source driver 450, a gate driver 460 and a processing module 470.

The high pass filter 410 processes the image input signal IN_{R/G/B} to generate a filtering result S_{HF}. The low pass filter 420 processes the image input signal IN_{R/G/B} to generate a filtering result S_{LF}. The processor 430 processes the filtering result S_{HF} to generate a processing signal S_{P}.

In this embodiment, the process of the processor 430 avoids the situation where the display panel displays an artifact issue. The invention does not limit how the processor 430 processes the filtering result S_{HF}. In one embodiment, the processor 430 executes a rendering process or an anti-aliasing process for the filtering result S_{HF}.

The combiner 440 combines the processing signal S_{P} with the filtering result S_{LF} to generate a combined image S_{COM}. The source driver 450 generates the data signals D₁˜Dₘ to the display panel 130 according to the combined image S_{COM} and a timing signal S_{C1}. The gate driver 460 generates the scan signals S₁˜Sₙ to the display panel 130 according to a timing signal S_{C2}. The processing module 470 generates the timing signals S_{C1} and S_{C2} according to the image input signal IN_{R/G/B} and the synchronization signal group Syne.

In this embodiment, the processing module 470 comprises an operation processor 471, a refresh rate modulator 472 and a timing controller (TCON) 473. The operation processor 471 determines whether the image input signal IN_{R/G/B} is a still image or a motion picture.

The invention does not limit how the operation processor 471 determines whether the image input signal IN_{R/G/B} is a still image or a motion picture. In one embodiment, the operation processor 471 calculates a bit number of various continuous image input signals and then determines whether the image input signal IN_{R/G/B} is a still image or a motion picture according to the calculated result. In other embodiments, the operation processor 471 calculates a checksum of each image input signal according to an operation rule and then compares various continuous checksums to determine whether the current image input signal is a still image or a motion picture. In other embodiments, those skilled in the field know of other methods to determine whether the image input signal IN_{R/G/B} is a still image or a motion picture, thus, the descriptions of the determining methods are omitted for brevity.

The refresh rate modulator 472 processes the synchronization signal group Sync to generate a plurality of adjustment signals S_{ADJ} according to a determined result S_{OP} generated by the operation processor 471. Since the synchronization signal group Sync comprises various synchronization signals, the refresh rate modulator 472 can generate the different adjustment signals S_{ADJ} according to the various synchronization signals.

In one embodiment, if the image input signal IN_{R/G/B} is a still image, the refresh rate modulator 472 adjusts the frequency of the synchronization signals of the synchronization signal group Sync to increase the refresh rate of the display panel. On the contrary, if the image input signal IN_{R/G/B} is a motion picture, the refresh rate modulator 472 does not adjust the frequency of the synchronization signals of the synchronization signal group Sync to maintain the refresh rate of the display panel and reduce power consumption.

The TCON 473 generates the timing signals S_{C1} and S_{C2} according to the adjustment signals S_{ADJ}. In this embodiment, the TCON 473 provides the appropriate timing signals S_{C1} and S_{C2} to the source driver 450 and the gate driver 460 according to the kind (still image or motion picture) of the image input signal IN_{R/G/B}. Thus, the source driver 450 and the gate driver 460 generate the data signals D₁˜Dₘ and the scan signals S₁˜Sₙ to display a corresponding image according to the kind of the image input signal IN_{R/G/B}.

For example, when the image input signal IN_{R/G/B} is a still image, the refresh rate of the display panel 130 is increased to avoid the situation where a flicker issue occurs to an image displayed by the display panel 130. Contrarily, when the image input signal IN_{R/G/B} is a motion picture, the refresh rate of the display panel 130 is maintained to avoid the situation where the power consumption is increased.

In other embodiments, the driving circuit 110 further comprises a signal level generator (not shown) to generate the levels (e.g. PVDD, PVEE, V_{R}˜V_{W}, S_{REF}) required by the pixels P₁₁˜Pₘₙ and the control signals (e.g. S_{DIS}, EMIT_RW, EMIT_GB, S_{SEL}). In one embodiment, the signal level generator can be combined with the source driver 450, the gate driver 460 or other circuits.

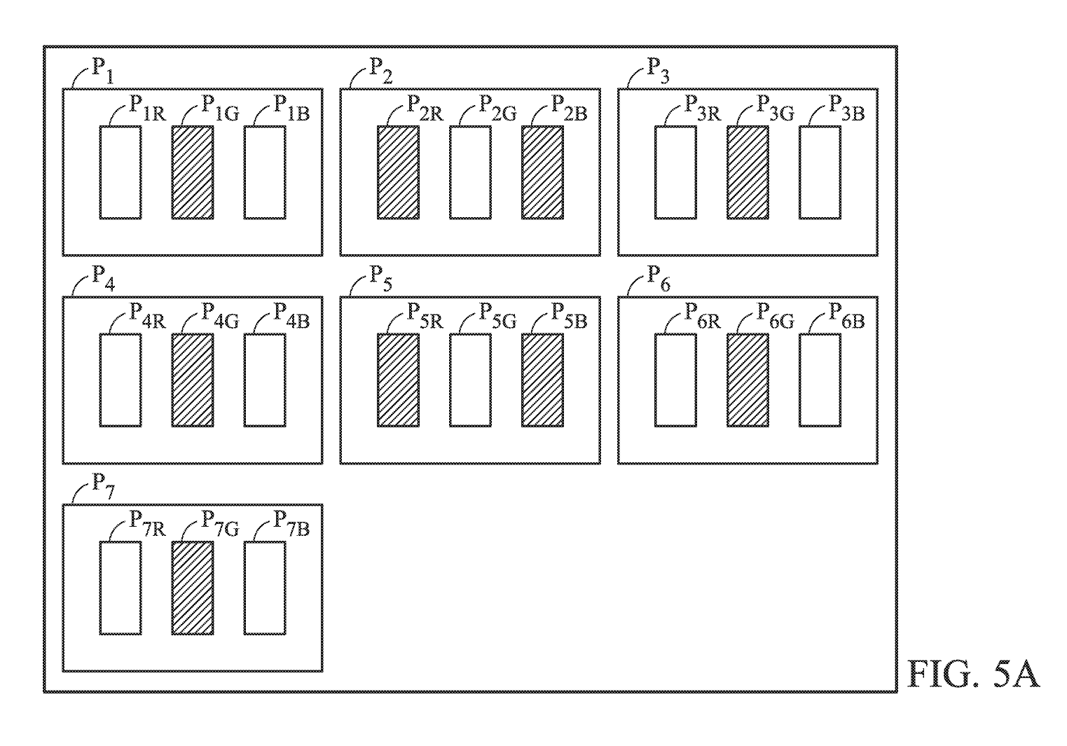

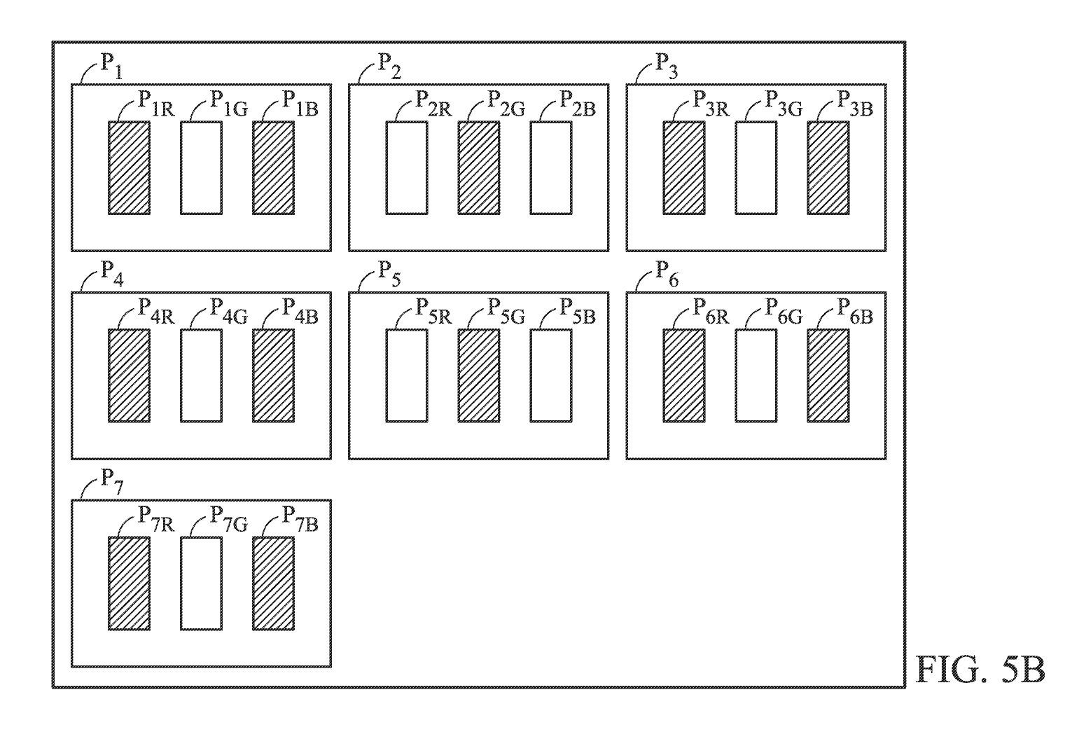

FIGS. 5A and 5B are schematic diagrams of exemplary embodiments of a control method to light pixels. For clarity, only seven pixels P₁˜P₇ are shown in FIGS. 5A and 5B. In this embodiment, each pixel comprises three sub-pixels to provide a red light, a green light and a blue light. In other embodiments, each pixel comprises four sub-pixels to provide a red light, a green light, a blue light and a white light.

In this embodiment, the sub-pixels of each pixel are sequentially arranged. For example, the sub-pixels P_{1R}, P_{1G} and P_{1B} of the pixel P₁ are sequentially arranged along a horizontal direction. Additionally, each of the pixels P₁˜P₇ are coupled to a corresponding scan electrode. In this embodiment, the pixels P₁˜P₃ are sequentially arranged and are coupled to a first scan electrode. The pixels P₄˜P₆ are sequentially arranged and are coupled to a second scan electrode. The pixel P₇ is coupled to a third scan electrode. The first, the second and the third scan electrodes are sequentially arranged.

During the different frame periods, the different sub-pixels are lighted. The invention does not limit which sub-pixel is lighted. In this embodiment, only a half of all sub-pixels are lighted during each frame time. Refer to FIG. 5A, when the sub-pixels P_{1R} and P_{1B} of the pixel P₁ are lighted and the sub-pixel P_{1G} of the pixel P₁ is not lighted, the sub-pixel P_{2G} of the pixel P₂ is lighted, the sub-pixels P_{2R} and P_{2B} of the pixel P₂ are not lighted, the sub-pixels P_{3R} and P_{3B} of the pixel P₃ are lighted and the sub-pixel P_{3G} of the pixel P₃ is not lighted.

In one embodiment, the lighting situations of the pixels P₁, P₃, P₄, P₆ and P₇ are the same but different from the lighting situations of the pixels P₂ and P₅. As shown in FIG. 5A, when the sub-pixels P_{1R} and P_{1B} of the pixel P₁ are lighted and the sub-pixel P_{1G} of the pixel P₁ is not lighted, the sub-pixels P_{3R}, P_{3B}, P_{4R}, P_{4B}, P_{6R}, P_{6B}, P_{7R} and P_{7B} of the pixels P₃, P₄, P₆ and P₇ are lighted and the sub-pixels P_{3G}, P_{4G}, P_{6G} and P_{7G} of the pixels P₃, P₄, P₆ and P₇ are not lighted. At this time, the sub-pixels P_{2G} and P_{5G} of the pixels P₂ and P₅ are lighted and the sub-pixels P_{2R}, P_{2B}, P_{5R} and P_{5B} of the pixels P₂ and P₅ are not lighted.

Assuming FIG. 5A shows the lighting situations of the pixels P₁˜P₇ during a first frame period, and FIG. 5B shows the lighting situations of the pixels P₁˜P₇ during a second frame period. The lighting situations of the pixels P₁˜P₇ in FIG. 5A are different from the lighting situations of the pixels P₁˜P₇ in FIG. 5B.

As shown in FIG. 5B, during the second frame period, the sub-pixels P_{1G}, P_{3G}, P_{4G}, P_{6G} and P_{7G} of the pixels P₁, P₃, P₄, P₆ and P₇ are lighted, and the sub⁻pixels P_{1R}, P_{1B}, P_{3R}, P_{3B}, P_{4R}, P_{4B}, P_{6R}, P_{6B}, P_{7R} and P_{7B} of the pixels P₁, P₃, P₄, P₆ and P₇ are not lighted. At this period, the sub-pixels P_{2R}, P_{2B}, P_{5R} and P_{5B} of the pixels P₂ and P₅ are lighted, and the sub-pixels P_{2G} and P_{5G} are not lighted.

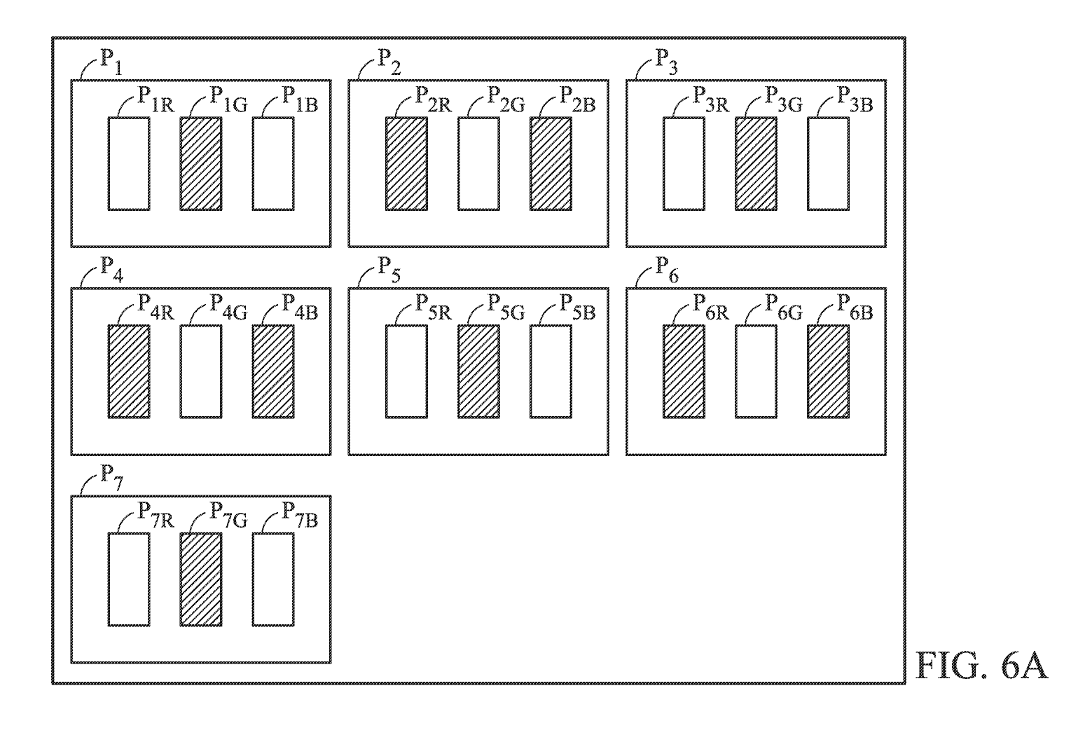

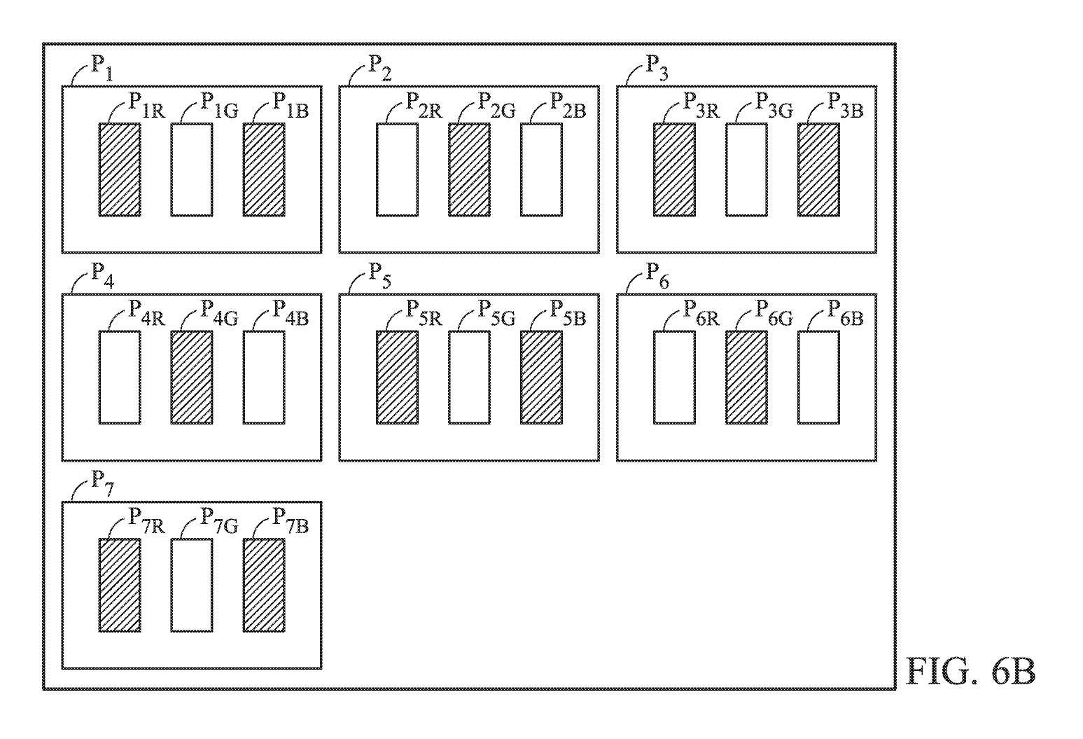

In FIG. 5A, the lighting situations of the pixels arranged in one column (vertical direction) are the same but different from the lighting situations of the pixels arranged in a neighbor column. In other embodiment, the lighting situations of the sub-pixels of one pixel are different from that of a neighbor pixel. As shown in FIG. 6A, when the sub-pixels P_{1R} and P_{1B} of the pixel P₁ are lighted and the sub-pixel P_{1G} of the pixel P₁ is not lighted, the sub-pixel P_{4G} of the pixel P₄ is lighted and the sub-pixels P_{4R} and P_{4B} of the pixel P₄ are not lighted. At this time, the sub-pixels P_{7R} and P_{7B} of the pixel P₇ are lighted and the sub-pixel P_{7G} of the pixel P₇ is not lighted. In this case, the lighting situations of the pixels P₂, P₄ and P₆ are the same and are different from the lighting situations of the pixels P₁, P₃, P₅ and P₇.

Assuming FIG. 6A shows the lighting situations of the pixels P₁˜P₇ during a first frame period, and FIG. 6B shows the lighting situations of the pixels P₁˜P₇ during a second frame period, as shown in FIG. 6B, the sub-pixels P_{1R}, P_{1B}, P_{2G}, P_{3R}, P_{3B}, P_{4G}, P_{5R}, P_{5B}, P_{6G}, P_{7R} and P_{7B} are not lighted, and the sub-pixels P_{1G}, P_{2R}, P_{2B}, P_{3G}, P_{4R}, P_{4B}, P_{5G}, P_{6R}, P_{6B} and P_{7G} are lighted.

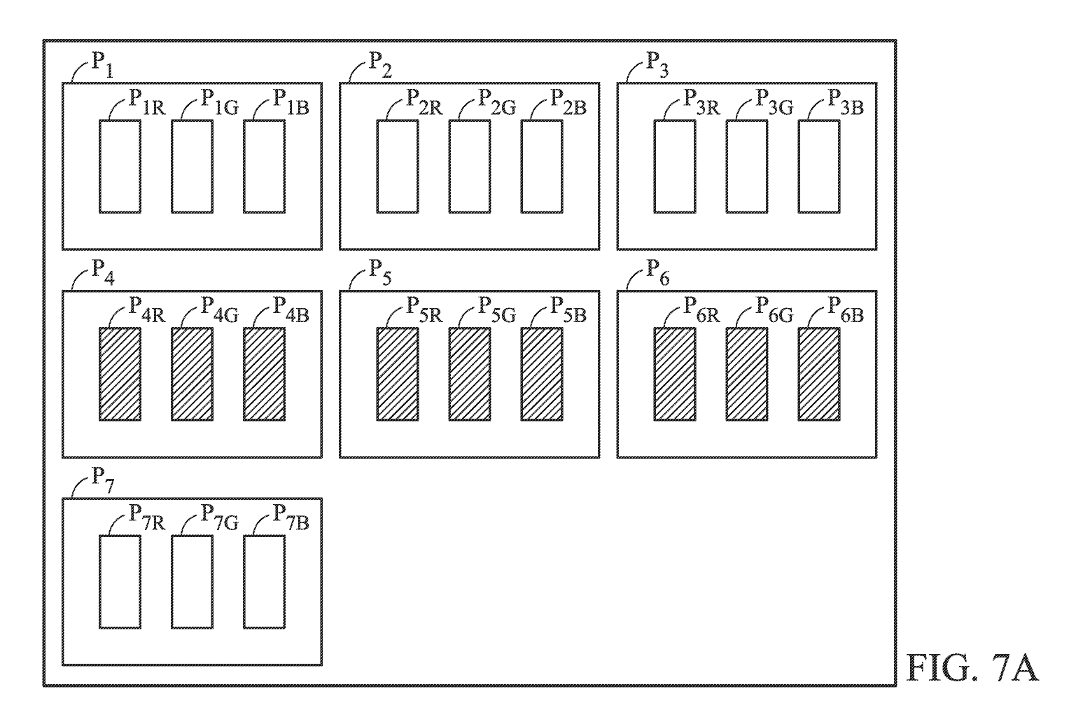

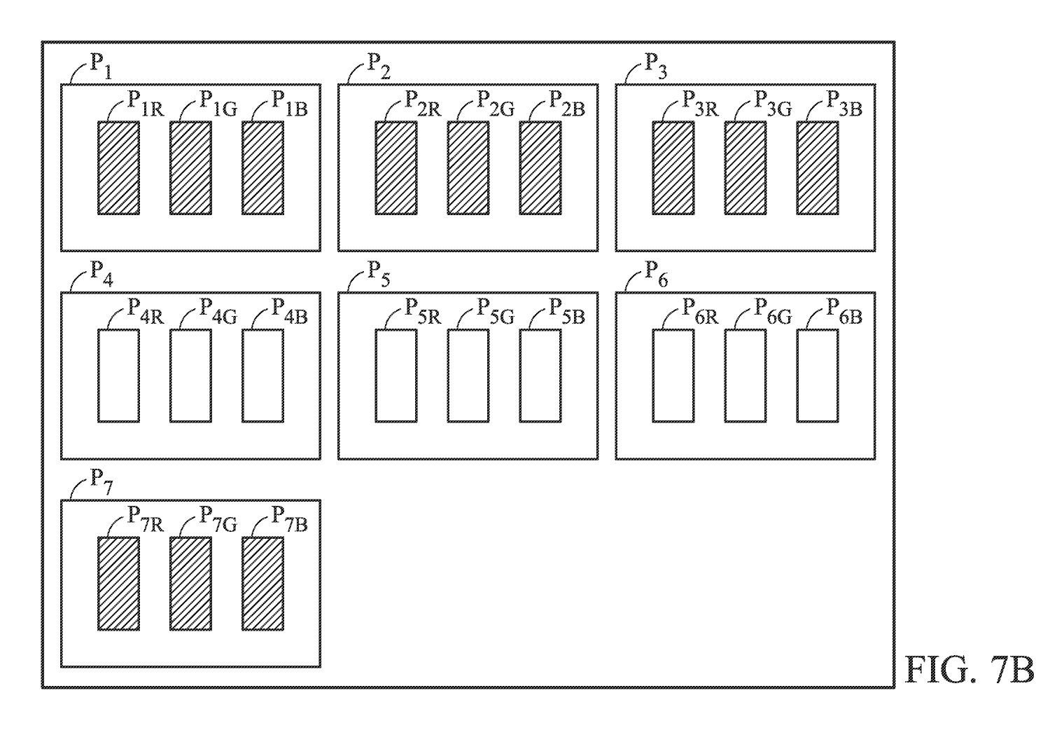

FIGS. 7A and 7B are schematic diagrams of exemplary embodiments of the control method to light pixels. The pixel arrange in FIG. 7A is the same as the pixel arrange in FIG. 5A, thus, the description of the pixel arrangement in FIG. 7A is omitted for brevity. In this embodiment, the lighting situations of the sub-pixel in a row (horizontal direction) are different from that in a neighbor row. As shown in FIG. 7A, when the sub-pixels P_{1R}, P_{1G} and P_{1B} of the pixel P₁ are lighted, the sub-pixels P_{2R}, P_{2G}, P_{2B}, P_{3R}, P_{3G} and P_{3B} of the pixels P₂ and P₃ are lighted. In this case, when the sub-pixels P_{1R}, P_{1G} and P_{1B} of the pixel P₁ are lighted, the sub-pixels of the pixels P₄˜P₆ are not lighted and the sub-pixels P_{7R}, P_{7G} and P_{7B} of the pixel P₇ are lighted.

Assuming FIG. 7A shows the lighting situations of the pixels P₁˜P₇ during a first frame period, and FIG. 7B shows the lighting situations of the pixels P₁˜P₇ during a second frame period, all sub-pixels of the pixels P₁˜P₃ and P₇ are lighted and the sub-pixels of the pixels P₄˜P₆ are not lighted during the first frame period. All sub-pixels of the pixels P₁˜P₃ and P₇ are not lighted and the sub-pixels of the pixels P₄˜P₆ are lighted during the second frame period.

As the above describes, a flicker issue does not occur to an image displayed by a display panel according the control method shown in FIGS. 5A˜7B. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display system, comprising:
a driving circuit generating a plurality of data signals and a plurality of scan signals according to an image input signal and a plurality of synchronization signals; and
a display panel displaying an image according to the data signals and the scan signals and comprising:
a first driving unit comprising a first driving transistor to generate a first driving current;
a second driving unit comprising a second driving transistor to generate a second driving current;
a first luminous element, which is lighted according to the first driving current when a first emitting signal is activated;
a second luminous element, which is lighted according to the first driving current when a second emitting signal is activated; and
a third luminous element, which is lighted according to the second driving current when the first emitting signal is activated.

2. The display system as claimed in claim 1, wherein when the first luminous element is lighted, the second luminous element is not lighted, and when the second luminous element is lighted, the first luminous element is not lighted.

3. The display system as claimed in claim 2, wherein when the first luminous element is lighted, the third luminous element is lighted, and when the first luminous element is not lighted, the third luminous element is not lighted.

4. The display system as claimed in claim 1, wherein when the first luminous element is lighted, a first light is provided by the first luminous element, when the second luminous element is lighted, a second light is provided by the second luminous element, and when the third luminous element is lighted, a third light is provided by the third luminous element, and colors of the first, the second and the third lights are not the same.

5. The display system as claimed in claim 1, wherein when the first luminous element is lighted, a first light is provided by the first luminous element, when the second luminous element is lighted, a second light is provided by the second luminous element, and when the third luminous element is lighted, a third light is provided by the third luminous element,
wherein the color of the first light is the same as the color of the second light, and the color of the first light is different from the color of the third light.

6. The display system as claimed in claim 1, wherein the first driving unit further comprises:
a first emitting transistor coupled to the first driving transistor and the first luminous element in series between a first operation voltage and a second operation voltage; and
a second emitting transistor coupled to the first driving transistor and the second luminous element in series between the first and the second operation voltages.

7. The display system as claimed in claim 1, wherein the first driving transistor is coupled to the first luminous element in series between a first operation voltage and the first emitting signal, and the second driving transistor is coupled to the second luminous element in series between the first operation voltage and the second emitting signal.

8. The display system as claimed in claim 7, wherein when a difference between the first operation voltage and the first emitting signal exceeds a threshold voltage of the first luminous element, the first luminous element is lighted according and the second emitting signal exceeds a threshold voltage of the second luminous element, the second luminous element is lighted according to the first driving current.

9. The display system as claimed in claim 1, wherein the driving circuit comprises:
a high pass filter processing the image input signal to generate a first filtering result;
a low pass filter processing the image input signal to generate a second filtering result;
a processor processing the first filtering result to generate a processing signal;
a combiner combining the first processing signal with the second filtering result to generate a combined image;
a source driver generating the data signals to the display panel according to the combined image and a first timing signal; and
a gate driver generating the scan signals to the display panel according to a second timing signal.

10. The display system as claimed in claim 9, wherein the driving circuit further comprises:
an operation processor determining whether the image input signal is a still image or a motion picture;
a refresh rate modulator processing the synchronization signals to generate a plurality of adjustment signals according to a determined result generated by the operation processor; and
a timing controller generating the first and the second timing signals according to the adjustment signals.

11. The display system as claimed in claim 1, wherein the first driving current is not interfered with by a threshold voltage of the first driving transistor and the second driving current is not interfered with by a threshold voltage of the second driving transistor.

12. A control method controlling a plurality of pixels, wherein each pixel is coupled to one of a first scan electrode, a second scan electrode and a third scan electrode and comprises a first sub-pixel, a second sub-pixel and a third sub-pixel, and the first, the second and the third scan electrodes are sequentially arranged, the first, the second and the third sub-pixels are sequentially arranged along a horizontal direction, a first pixel, a second pixel and a third pixel among the pixels are sequentially arranged and are coupled to the first scan electrode, a fourth pixel, a fifth pixel and a sixth pixel among the pixels are sequentially arranged and are coupled to the second scan electrode, and a seventh pixel among the pixels is coupled to the third scan electrode, comprising:
lighting a portion of the sub-pixels of the pixel;
when the first and the third sub-pixels of the first pixel are lighted and the second sub-pixel of the first pixel is not lighted, a second sub-pixel of the second pixel is lighted, a first sub-pixel and a third sub-pixel of the second pixel are not lighted, a first sub-pixel and a third sub-pixel of the third pixel are lighted, and a second sub-pixel of the third pixel is not lighted; and
when the first, the second and the third sub-pixels are lighted, the first, the second and the third sub-pixels of the second and the third pixels are lighted.

13. The control method as claimed in claim 12, wherein when the first and the third sub-pixels of the first pixel are lighted and the second sub-pixel of the first pixel is not lighted, the first and the third sub-pixels of the fourth, the sixth and the seventh pixels are lighted and the second sub-pixels of the fourth, the sixth and the seventh pixels are not lighted.

14. The control method as claimed in claim 12, wherein when the first and the third sub-pixels of the first pixel are lighted and the second sub-pixel of the first pixel is not lighted, the second sub-pixel of the fourth pixel is lighted and the first and the third sub-pixels of the fourth pixel are not lighted.

15. The control method as claimed in claim 14, wherein when the first and the third sub-pixels of the first pixel are lighted and the second sub-pixel of the first pixel is not lighted, the first and the third sub-pixels of the fifth pixel are lighted and the second sub-pixel of the fifth pixel is not lighted.

16. The control method as claimed in claim 15, wherein when the first and the third sub-pixels of the first pixel are lighted and the second sub-pixel of the first pixel is not lighted, the first and the third sub-pixels of the seventh pixel are lighted and the second sub-pixel of the seventh pixel is not lighted

17. The control method as claimed in claim 12, wherein:
during a first frame period, the first and the third sub-pixels of the first pixel are lighted, the second sub-pixel of the first pixel is not lighted, the second sub-pixel of the second pixel is lighted, and the first and the third sub-pixels of the second pixel are not lighted; and
during a second frame period, the second sub-pixels of the first and the third pixels are lighted, the first and the third sub-pixels of the first and the third pixels are not lighted, the first and the third sub-pixels of the second pixel are light, and the second sub-pixel of the second pixel is not lighted.

18. The control method as claimed in claim 12, wherein:
during a first frame time, the first, the second and the third sub-pixels of the first, the second, the third and the seventh pixels are lighted and the first, the second and the third sub-pixels of the fourth, the fifth and the sixth pixels are not lighted; and
during a second frame period, the first, the second and the third sub-pixels of the first, the second, the third and the seventh pixels are not lighted and the first, the second and the third sub-pixels of the fourth, the fifth and the sixth pixels are lighted.
